(19) United States
(12) Patent Application Publication
(10) Pub. No.: US 2023/0360589 A1
(43) Pub. Date: Nov. 9, 2023

(54) DISPLAY DEVICE AND METHOD OF DRIVING THE SAME

(71) Applicant: SAMSUNG DISPLAY CO., LTD., Yongin-si (KR)

(72) Inventors: Jung Eon AN, Yongin-si (KR); Ki Hyun PYUN, Yongin-si (KR)

(21) Appl. No.: 18/192,004

(22) Filed: Mar. 29, 2023

(30) Foreign Application Priority Data
May 3, 2022 (KR) 10-2022-0054985

(51) Int. Cl. G09G 3/32

(52) U.S. Cl. CPC G09G 3/32; G09G 2310/08; G09G 2310/0275

(57) ABSTRACT

A display device includes: a first interface; a data driver providing first reference data to a first transmitter of the first interface; and a timing controller receiving second reference data through a first receiver of the first interface and comparing the first reference data with the second reference data to inspect signal transmission quality of the first interface for an error, wherein the first reference data is transmitted from the first transmitter to the first receiver via the first interface, wherein the timing controller changes a transmission state of the first interface when an error is detected in the signal transmission quality of the first interface, and wherein the transmission state of the first interface includes at least one of a transmission frequency, a driving current, or a termination resistance of the first interface.

### CROSS-REFERENCE TO RELATED APPLICATION

The application claims priority under 35 U.S.C. § 119(a) to Korean Patent Application No. 10-2022-0054985, filed on May 3, 2022, the disclosure of which is incorporated by reference herein in its entirety.

### TECHNICAL FIELD

The present invention relates to a display device and a method of driving the same.

### DISCUSSION OF THE RELATED ART

Generally, a display device may perform driving operation to compensate for deterioration or characteristic changes of a driving transistor included in a pixel circuit by sensing a threshold voltage or mobility of the driving transistor included in the pixel circuit.

### SUMMARY

According to an embodiment of the present invention, a display device includes: a first interface; a data driver providing first reference data to a first transmitter of the first interface; and a timing controller receiving second reference data through a first receiver of the first interface and comparing the first reference data with the second reference data to inspect signal transmission quality of the first interface for an error, wherein the first reference data is transmitted from the first transmitter to the first receiver via the first interface, wherein the timing controller changes a transmission state of the first interface when an error is detected in the signal transmission quality of the first interface, and wherein the transmission state of the first interface includes at least one of a transmission frequency, a driving current, or a termination resistance of the first interface.

In an embodiment of the present invention, the timing controller includes: a detector comparing the first reference data with the second reference data to inspect the signal transmission quality of the first interface; and a transmission state controller changing the transmission state of the first interface.

In an embodiment of the present invention, the detector compares a data value of the first reference data with a data value of the second reference data for each bit to inspect the signal transmission quality of the first interface, and wherein the detector determines that there is an error in the signal transmission quality of the first interface when the first reference data and the second reference data have different data values from each other in at least one bit.

In an embodiment of the present invention, the detector generates a first reception state abnormal signal when there is an error in the signal transmission quality of the first interface, and wherein the transmission state controller generates a transmission state control signal for changing the transmission state of the first interface based on the first reception state abnormal signal.

In an embodiment of the present invention, the display device further includes: a second interface, wherein the timing controller provides the transmission state control signal to a second transmitter of the second interface, and wherein the data driver changes at least one of the transmission frequency, the driving current, or the termination resistance of the first interface based on the transmission state control signal.

In an embodiment of the present invention, the transmission state controller includes: a frequency controller generating a frequency divider code for controlling a frequency of a data transmission clock signal of the first interface; a driving current controller generating a driving current code for controlling a driving current of the first transmitter of the first interface; and a termination resistor controller generating a termination resistance code for controlling a termination resistance of the first transmitter of the first interface.

In an embodiment of the present invention, the detector generates an inspection end signal and provides the inspection end signal to the data driver when there is no error in the signal transmission quality of the first interface.

In an embodiment of the present invention, the first reference data includes a predetermined data value having a specific pattern.

In an embodiment of the present invention, the timing controller sequentially changes the transmission frequency, the driving current, and the termination resistance of the first interface when an error is detected in the signal transmission quality of the first interface.

In an embodiment of the present invention, the display device further includes: a power supply generating a driving power source, wherein the timing controller blocks generation of the driving power source of the power supply when an error is detected in the signal transmission quality of the first interface.

According to an embodiment of the present invention, a display device includes: a first interface; a power supply generating a driving power source; a data driver providing first reference data to a first transmitter of the first interface; and a timing controller receiving second reference data through a first receiver of the first interface and comparing the first reference data with the second reference data to inspect signal transmission quality of the first interface for an error, wherein the first reference data is transmitted from the first transmitter to the first receiver via the first interface, wherein the timing controller blocks generation of the driving power source of the power supply when an error is detected in the signal transmission quality of the first interface.

According to an embodiment of the present invention, a method of driving a display device includes: transmitting first reference data from a first transmitter of a first interface to a first receiver; comparing second reference data received through the first receiver with the first reference data; inspecting signal transmission quality of the first interface for an error according to a comparison result between the first reference data and the second reference data; and changing transmission state of the first interface when it is determined that an error has occurred in the signal transmission quality of the first interface in the inspecting of the signal transmission quality, wherein the transmission state of the first interface includes at least one of a transmission frequency, a driving current, or a termination resistance of the first interface.

In an embodiment of the present invention, in the comparing of the second reference data with the first reference data, a data value of the first reference data and a data value of the second reference data are compared to each other for each bit.

In an embodiment of the present invention, in the inspecting of the signal transmission quality of the first interface, it is determined that there is an error in the signal transmission quality of the first interface when the first reference data and the second reference data have different data values from each other in at least one bit.

In an embodiment of the present invention, the first reference data includes a predetermined data value having a specific pattern.

In an embodiment of the present invention, the changing of the transmission state of the first interface includes: generating a frequency divider code for controlling a frequency of a data transmission clock signal of the first interface.

In an embodiment of the present invention, the changing of the transmission state of the first interface includes: generating a drive current code for controlling a drive current of the first transmitter of the first interface.

In an embodiment of the present invention, the changing of the transmission state of the first interface includes: generating a termination resistance code for controlling a termination resistance of the first transmitter of the first interface.

In an embodiment of the present invention, the changing of the transmission state of the first interface includes sequentially changing the transmission frequency, the driving current, and the termination resistance of the first interface.

In an embodiment of the present invention, the inspecting of the signal transmission quality of the first interface includes: blocking generation of a driving power source when it is determined that an error has occurred in the signal transmission quality of the first interface.

### BRIEF DESCRIPTION OF THE DRAWINGS

The above and other features of the present invention will become more apparent by describing in further detail embodiments thereof with reference to the accompanying drawings, in which:

FIG. 1 is a block diagram illustrating a display device according to an embodiment of the present invention.

FIG. 2 is a diagram illustrating an example of a signal supplied from a timing controller included in the display device of FIG. 1 to a data driver according to an embodiment of the present invention.

FIG. 3 is a circuit diagram illustrating an example of a pixel included in the display device of FIG. 1 according to an embodiment of the present invention.

FIG. 4 is a circuit diagram illustrating an example of the data driver included in the display device of FIG. 1 according to an embodiment of the present invention.

FIG. 5 is a diagram schematically illustrating an example of a method of driving the display device of FIG. 1 according to an embodiment of the present invention.

FIGS. 6A and 6B are waveform diagrams for explaining an example of an operation of the pixel of FIG. 3 according to an embodiment of the present invention.

FIG. 7 is a block diagram illustrating an example of the timing controller and the data driver included in the display device of FIG. 1 according to an embodiment of the present invention.

FIG. 8 is a diagram for explaining an example of a signal supplied from the timing controller of FIG. 7 to the data driver according to an embodiment of the present invention.

FIG. 9 is a block diagram illustrating an example of the timing controller and the data driver included in the display device of FIG. 1 according to an embodiment of the present invention.

FIG. 10 is a flowchart illustrating a method of driving a display device according to an embodiment of the present invention.

FIG. 11 is a flowchart illustrating a method of driving a display device according to an embodiment of the present invention.

### DETAILED DESCRIPTION OF THE EMBODIMENTS

Hereinafter, embodiments of the present invention will be described in more detail with reference to the accompanying drawings. The same reference numerals may be used for the same elements in the drawings, and duplicate descriptions for the same elements may be omitted.

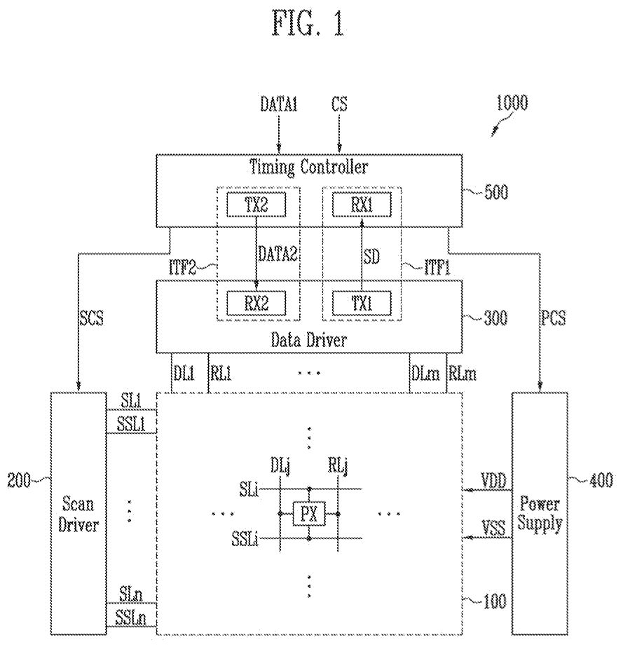

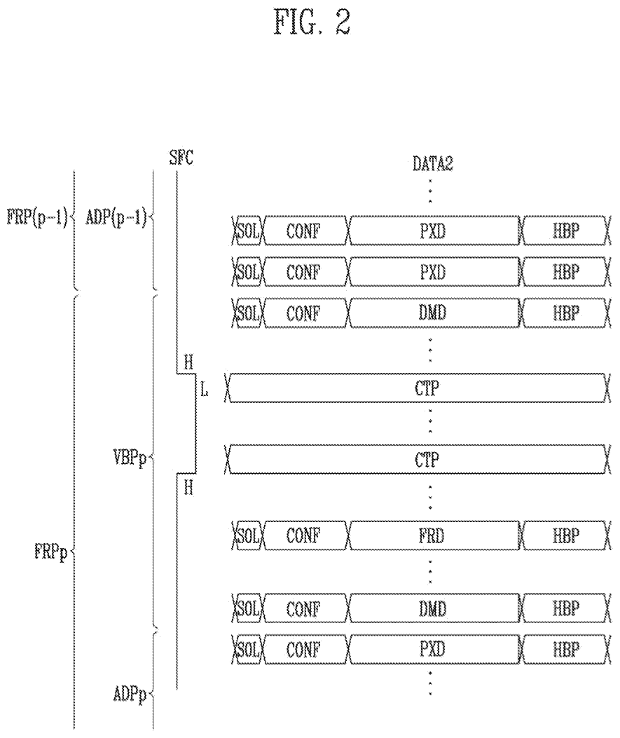

FIG. 1 is a block diagram illustrating a display device according to an embodiment of the present invention. FIG. 2 is a diagram illustrating an example of a signal supplied from a timing controller included in the display device of FIG. 1 to a data driver according to an embodiment of the present invention.

Referring to FIG. 1, a display device 1000 may include a pixel unit 100 (or a display panel), a scan driver 200, a data driver 300, a power supply 400, and a timing controller 500.

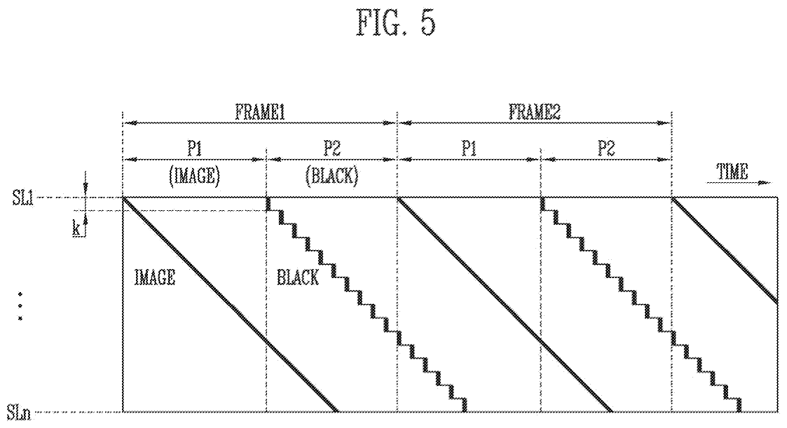

In an embodiment of the present invention, the display device 1000 may be driven by being divided into a display period for displaying an image (for example, the first scan period P1 of FIG. 5) and a sensing period for sensing characteristics of a driving transistor included in each of pixels PX and/or characteristics of a light emitting element (for example, the second scan period P2 of FIG. 5).

The pixel unit 100 may include scan lines SL1 to SLn, sensing scan lines SSL1 to SSLn, data lines DL1 to DLm, sensing lines RL1 to RLm (or reception lines), and pixels PX, where n and m may be integers greater than 0. The pixel unit 100 may include a plurality of pixel rows and a plurality of pixel columns. The pixel rows may correspond to the scan lines SL1 to SLn and the sensing scan lines SSL1 to SSLn, and the pixel columns may correspond to the data lines DL1 to DLm and the sensing lines RL1 to RLm.

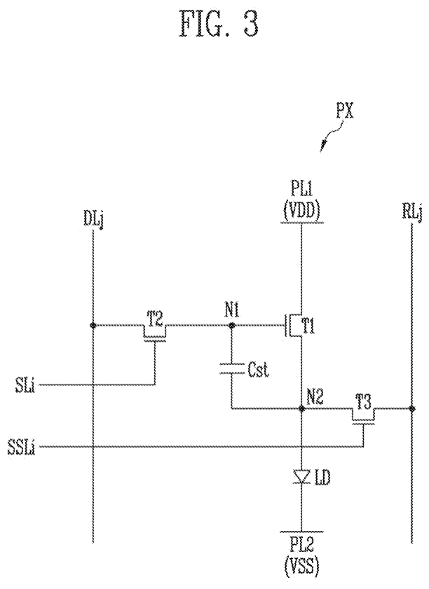

Each of the pixels PX may be connected to at least one of the scan lines SL1 to SLn, at least one of the sensing scan lines SSL1 to SSLn, at least one of the data lines DL1 to DLm, and at least one of the sensing lines RL1 to RLm. Each of the pixels PX may emit light with a luminance corresponding to a data signal provided through a corresponding data line in response to a scan signal provided through a corresponding scan line. A detailed configuration and operation of a pixel PX will be described later with reference to FIG. 3.

The pixels PX may receive voltages of a first power source VDD and a second power source VSS from the power supply 400. Here, the first power source VDD and the second power source VSS may be voltages for operating the pixels PX.

In addition, although n scan lines SL1 to SLn and n sensing scan lines SSL1 to SSLn are shown in FIG. 1, embodiments of the present invention are not limited thereto. For example, one or more control lines, scan lines, sensing scan lines, and the like may be additionally formed in the pixel unit 100 to correspond to the circuit structure of the pixel PX.

In an embodiment of the present invention, the pixels PX of the pixel unit 100 may be divided into a plurality of pixel blocks. Each of the pixel blocks may include predetermined number of consecutive pixel rows. For example, each of the pixel blocks may include k pixel rows, where k may be a positive integer greater than or equal to 2 and less than n.

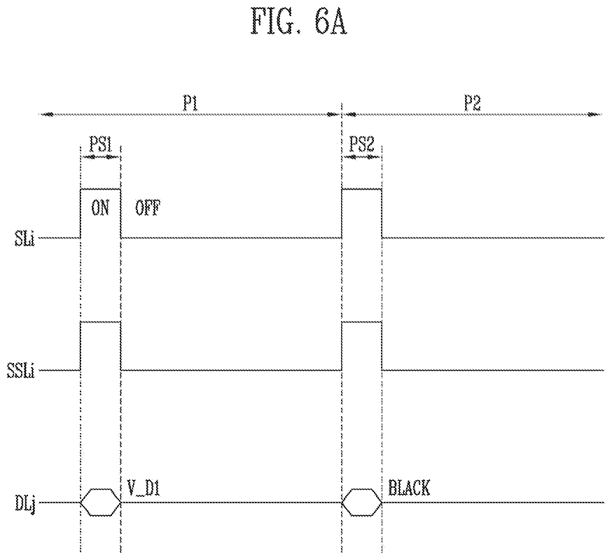

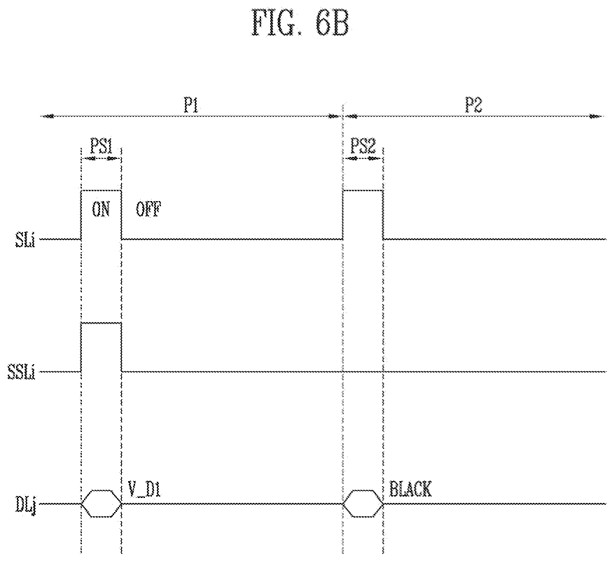

In addition, a black image insertion driving may be performed in units of pixel blocks. In an embodiment of the present invention, a black data signal may be simultaneously supplied to pixel rows included in each of the pixel blocks to display a black image in a corresponding pixel block for a predetermined period. The black image insertion driving will be described later with reference to FIGS. 5, 6A, and 6B.

The timing controller 500 may receive a control signal CS and first data DATA1 from an external device (for example, a graphic processor). Here, the control signal CS may include a clock signal, a vertical synchronization signal, a horizontal synchronization signal, and the like.

The timing controller 500 may generate a scan control signal SCS based on the control signal CS and supply the scan control signal SCS to the scan driver 200.

The scan control signal SCS may include a scan start signal, a sensing scan start signal, a clock signal, and the like. The scan start signal may control timing of the scan signal. The sensing scan start signal may control timing of a sensing scan signal. The clock signal included in the scan control signal SCS may be used to shift the scan start signal and/or the sensing scan start signal.

The timing controller 500 may generate second data DATA2 based on the control signal CS and the first data DATA1, and supply the second data DATA2 to the data driver 300 through a second interface ITF2. For example, the timing controller 500 may include a second transmitter TX2 of the second interface ITF2.

In an embodiment of the present invention, the second interface ITF2 may be a serial interface (or, e.g., a high-speed serial interface). For example, the timing controller 500 may provide clock-embedded second data DATA2 in the form of a packet to the data driver 300 through the second interface ITF2. To this end, the data driver 300 and the timing controller 500 may be connected and communicate with each other through, for example, USI (Universal Serial Interface), USI-T (Universal Serial Interface for TV), or UDDI (Universal Description, Discovery, and Integration) as the second interface ITF2.

According to an embodiment of the present invention, the timing controller 500 may generates a data control signal based on the control signal CS, generate image data based on the control signal CS and the first data DATA1, and supply the second data DATA2, in which the data control signal and the image data are composed of one packet data, to the data driver 300 through the second interface ITF2.

The data control signal may include a signal for an initialization operation of the data driver 300, for example, a clock training signal. The clock training signal may include a clock training pattern. In addition, frame data may include pixel data and the like.

In addition, the timing controller 500 may supply a training notification signal to the data driver 300 for notification of a section (or clock training section) in which a clock training pattern of the clock training signal is supplied. For example, the timing controller 500 may supply the training notification signal of a first level (or, e.g., a logic low level) to the data driver 300 in response to the clock training section, and may supply the training notification signal of a second level (or, e.g., a logic high level) higher than the first level to the data driver 300 in response to other sections.

FIG. 2 may be referred to in more detail to describe signals (for example, the second data DATA2 and the training notification signal) supplied from the timing controller 500 to the data driver 300.

Referring further to FIG. 2, a frame period for each image frame may include a vertical blank period and an active data period. For example, a p-th frame period FRPp may include a p-th vertical blank period VBPp and a p-th active data period ADPp, where p may be a natural number.

Active data periods ADP(p−1) and ADPp may be periods in which grayscale values constituting an image frame, which is to be displayed by the pixel unit 100, are supplied. The grayscale values may be included in pixel data PXD (or, e.g., image data).

The vertical blank period VBPp may be positioned between an active data period ADP(p−1) of a previous frame (for example, a (p−1)^{th} frame period FRP(p−1)) and an active data period ADPp of a current frame (for example, the p-th frame period FRPp). During the vertical blank period VBPp, clock training, frame setting, dummy data supply, and the like may be performed. The vertical blank period VBPp may sequentially include a supply period of dummy data DMD, a supply period of a clock training pattern CTP, a supply period of frame data FRD, and the supply period of the dummy data DMD.

The timing controller 500 may notify the data driver 300 that the clock training pattern CTP is being supplied through the second interface ITF2 by providing a training notification signal SFC of a first level (or, e.g., a logic low level L) to the data driver 300 during the vertical blank period VBPp. When the clock training pattern CTP is not supplied through the second interface ITF2, the timing controller 500 may provide the training notification signal SFC of a second level (or, e.g., a logic high level H) to the data driver 300.

In the active data periods ADP(p−1) and ADPp, a line start packet SOL (e.g., a start of line), a line setting packet CONF, an image data packet (for example, the pixel data PXD, the frame data FRD, or the dummy data DMD), and a horizontal blank period packet HBP may be sequentially supplied in units of pixel rows.

The line start packet SOL may notify the data driver 300 that the supply of a signal to the changed pixel row is started.

The horizontal blank period packet HBP may notify the data driver 300 that a pixel row (for example, pixels PX connected to the same scan line) corresponding to the image data packet such as the pixel data PXD is changed.

The line setting packet CONF may include an operation option of the data driver 300. For example, the line setting packet CONF may indicate that subsequent data is the pixel data PXD or the dummy data DMD.

Referring back to FIG. 1, in an embodiment of the present invention, the timing controller 500 may detect a change in characteristics of the driving transistor based on a current or voltage extracted from the pixel PX. For example, the timing controller 500 may detect a change in characteristics of the driving transistor based on sensing data SD provided from the data driver 300 through a first interface ITF1. The timing controller 500 may include a first receiver RX1 of the first interface ITF1.

The timing controller 500 may calculate a compensation value for compensating the first data DATA1 based on the detected change in characteristics based on the sensing data SD. In addition, the timing controller 500 may compensate image data (for example, grayscale values of the pixel data PXD, refer to FIG. 2) included in the second data DATA2 based on the compensation value. Here, the sensing period may be a vertical blank period between the display period and the adjacent display period (for example, another frame period).

In an embodiment of the present invention, the timing controller 500 may select one pixel row from among the plurality of pixel rows during the sensing period and control the data driver 300 to perform a sensing operation on the selected pixel row. However, the present invention is not limited thereto, and the timing controller 500 may select two or more pixel rows during the sensing period.

The timing controller 500 may generate a power control signal PCS based on the control signal CS and may supply the power control signal PCS to the power supply 400.

The scan driver 200 may receive the scan control signal SCS from the timing controller 500. The scan driver 200 may supply the scan signal to the scan lines SL1 to SLn and may supply the sensing scan signal to the sensing scan lines SSL1 to SSLn.

For example, the scan driver 200 may sequentially supply the scan signal to the scan lines SL1 to SLn. When the scan signal is sequentially supplied to the scan lines SL1 to SLn, the pixels PX may be selected in units of horizontal lines (or, e.g., pixel rows). To this end, the scan signal may be set to a gate-on voltage (for example, a logic high level) so that transistors included in the pixels PX are turned on.

Similarly, the scan driver 200 may supply the sensing scan signal to the sensing scan lines SSL1 to SSLn. The sensing scan signal may be used to sense (or extract) a driving current flowing through the pixel (for example, a current flowing through the driving transistor). The timing and waveform to which the scan signal and the sensing scan signal are supplied may be set differently depending on the display period and the sensing period.

In addition, FIG. 1 shows an embodiment in which one scan driver 200 outputs both the scan signal and the sensing scan signal, but the present invention is not limited thereto. For example, the scan driver 200 may include a first scan driver that supplies the scan signal to the pixel unit 100 and a second scan driver that supplies the sensing scan signal to the pixel unit 100. For example, the first and second scan drivers may be implemented as separate components.

The data driver 300 may receive the second data DATA2 from the timing controller 500 through the second interface ITF2. For example, the data driver 300 may include a second receiver RX2 of the second interface ITF2.

The data driver 300 may determine a clock training period based on the training notification signal SFC of the first level (or, e.g., logic low level) (refer to FIG. 2) provided from the timing controller 500. The data driver 300 may generate (or, e.g., restore) a clock signal based on the second data DATA2 in the clock training period. For example, the data driver 300 may include a clock data recovery circuit (CDR circuit). The clock data recovery circuit may generate the clock signal based on the clock training signal of the second data DATA2 in the clock training period. For example, the clock data recovery circuit may be included in the second receiver RX2 of the second interface ITF2.

The data driver 300 may generate data signals based on the second data DATA2. For example, the data driver 300 may generate the data signals based on the image data included in the second data DATA2 and the clock signal generated (or, e.g., restored) in the clock training period.

The data driver 300 may supply the data signal to the data lines DL1 to DLm. In an embodiment of the present invention, the data driver 300 may supply the data signal to the pixel unit 100 in the first scan period (for example, the first scan period P1 of FIG. 5) of each of the pixels PX during one frame period. In addition, the data driver 300 may supply a black data signal to the pixel unit 100 in the second scan period (for example, the second scan period P2 of FIG. 5) during one frame period. In this case, the data signal may be a data voltage for displaying an image, that is, a data voltage corresponding to the first data DATA1, and the black data signal may be a data voltage corresponding to a black grayscale value (or, e.g., a predetermined low grayscale value).

In an embodiment of the present invention, the data driver 300 may supply a sensing data signal to pixels PX disposed in at least one pixel row selected to extract a current or voltage from the pixels PX during the sensing period.

In addition, the data driver 300 may detect sensing values (for example, a sensing current and a sensing voltage) from the sensing lines RL1 to RLm in units of pixel columns. For example, the data driver 300 may detect changes in threshold voltage Vth and mobility of the driving transistor included in the pixel PX, a change in characteristics of the light emitting element, and the like.

In an embodiment of the present invention, during the sensing period, the data driver 300 may receive the current or voltage extracted from the pixel PX through the sensing lines RL1 to RLm. The extracted current or voltage may correspond to a sensing value. The data driver 300 may provide the sensing value (or sensing data SD) corresponding to the detected change in characteristics to the timing controller 500 through the first interface ITF1. For example, the data driver 300 may include a first transmitter TX1 of the first interface ITF1.

The power supply 400 may be a driving power source for driving the pixel PX, and may supply a voltage of the first power source VDD and a voltage of the second power source VSS to the pixel unit 100. The voltage level of the second power source VSS may be lower than the voltage level of the first power source VDD. For example, the voltage of the first power source VDD may be a positive voltage, and the voltage of the second power source VSS may be a negative voltage.

In addition, when an error occurs in signal transmission quality of the first interface ITF1, miscorrection may occur when the timing controller 500 compensates for the image data included in the second data DATA2. For example, when damage occurs in the first transmitter TX1 and/or the first receiver RX1 of the first interface ITF1, or a short circuit occurs in a signal transmission line of the first interface ITF1, a value of the sensing data SD transmitted through the first interface ITF1 may be changed. For example, when an error occurs in the signal transmission quality of the first interface ITF1, a value of the sensing data SD that is to be transmitted by the data driver 300 and a value of the sensing data SD that is received by the timing controller 500 may be different to each other (for example, an error may occur in the sensing data SD received by the timing controller 500). When the timing controller 500 receiving the sensing data SD, which has the error in the signal transmission quality, compensates for the image data included in the second data DATA2 based on the sensing data SD, miscorrection may occur. In this case, the quality of an image displayed according to image data in which grayscale values are compensated based on the miscorrected compensation value may be degraded.

Accordingly, the display device 1000 according to an embodiment of the present invention may inspect the signal transmission quality of the first interface ITF1, which is for transmitting the sensing data SD, and change the transmission state of the first interface ITF1 when an error is detected in the sensing data SD that is transmitted through the first interface ITF1. Accordingly, the signal transmission quality of the first interface ITF1 can be increased (for example, removed).

In addition, when the signal transmission quality is not increased (e.g., removed) even when the transmission state of the first interface ITF1 is changed, the display device 1000 according to an embodiment of the present invention may cut off the supply of the power source (for example, the first power source VDD and/or the second power source VSS) for operating the pixel unit 100. Accordingly, the displayed image according to the miscorrected image data (or the second data DATA2) can be prevented.

FIG. 3 is a circuit diagram illustrating an example of a pixel included in the display device of FIG. 1 according to an embodiment of the present invention.

In FIG. 3, for convenience of description and clarity, a pixel PX positioned on an i-th horizontal line (or an i-th pixel row) and connected to a j-th data line DLj is shown, where i and j may be natural numbers. The pixel PX shown in FIG. 3 may be substantially the same as the pixel PX shown in FIG. 1.

Referring to FIG. 3, the pixel PX may include a light emitting element LD and a pixel circuit (or a pixel driving circuit) connected thereto to control the amount of current flowing through the light emitting element LD.

The light emitting element LD may be connected between a first power source VDD and a second power source VSS. For example, a first electrode (for example, an anode electrode) of the light emitting element LD may be connected to a first power source line PL1 to which a voltage of the first power source VDD is applied via the pixel circuit, and a second electrode (for example, a cathode electrode) of the light emitting element LD may be connected to a second power source line PL2 to which a voltage of the second power source VSS is applied. The light emitting element LD may emit light with a luminance corresponding to a driving current provided from the pixel circuit.

In an embodiment of the present invention, the light emitting element LD may be an organic light emitting diode including an organic light emitting layer. In an embodiment of the present invention, the light emitting element LD may be an inorganic light emitting diode formed of an inorganic material, such as a micro light emitting diode (LED), a quantum dot light emitting diode, or the like. In an embodiment of the present invention, the light emitting element LD may be a light emitting element composed of a composite of an organic material and an inorganic material.

In addition, FIG. 3 illustrates the pixel PX including a single light emitting element LD. However, in an embodiment of the present invention, the pixel PX may include a plurality of light emitting elements. The plurality of light emitting elements may be connected to each other in series, in parallel, or in series and parallel. For example, the light emitting element LD may have a form in which a plurality of light emitting elements (for example, organic light emitting elements and/or inorganic light emitting elements) are connected between the second power source line PL2 and a second node N2 in series, in parallel, or in series and parallel.

The pixel circuit may include at least one transistor and at least one capacitor. For example, the pixel circuit may include a first transistor T1 (or, e.g., a driving transistor), a second transistor T2 (or, e.g., a switching transistor), a third transistor T3 (or, e.g., a sensing transistor), and a storage capacitor Cst.

The first transistor T1 may be connected between the first power source line PL1 and the second node N2, and may include a gate electrode connected to a first node N1.

The first transistor T1 may control a driving current (for example, the amount of driving current) flowing from the first power source line PL1 to the second power source line PL2 via the light emitting element LD in response to a data signal supplied to the first node N1 through a j-th data line DLj (hereinafter, referred to as a data line). To this end, the voltage of the first power source VDD may be set to be higher than the voltage of the second power source VSS. For example, the voltage of the first power source VDD may be a positive voltage, and the voltage of the second power source VSS may be a negative voltage.

The second transistor T2 may be connected between the data line DLj and the first node N1, and may include a gate electrode connected to an i-th scan line sLi (hereinafter, referred to as a scan line).

The second transistor T2 may be turned on when a scan signal having a voltage (for example, a gate-on voltage) capable of turning on the second transistor T2 is supplied from the scan line sLi to the gate electrode of the second transistor T2 so that the data line DLj and the first node N1 are electrically connected to each other. In this case, the data signal of a corresponding frame may be supplied to the data line DLj, and accordingly, the data signal may be transmitted to the first node N1. A voltage corresponding to the data signal that is transmitted to the first node N1 may be stored in the storage capacitor Cst.

The third transistor T3 may be connected between the second node N2 and a j-th sensing line RLj (hereinafter, referred to as a sensing line), and may include a gate electrode connected to an i-th sensing scan line SSLi (hereinafter, referred to as a sensing scan line).

The third transistor T3 may be turned on when a sensing scan signal having a voltage (for example, a gate-on voltage) capable of turning on the third transistor T3 is supplied from the sensing scan line SSLi to the third transistor T3 so that the second node N2 and the sensing line RLj are electrically connected to each other. In this case, a predetermined voltage (for example, an initialization voltage) may be supplied to the second node N2, or a sensing value (for example, the sensing data of FIG. 1) may be transmitted to the data driver 300 through the sensing line RLj.

One electrode of the storage capacitor Cst may be connected to the first node N1, and the other electrode of the storage capacitor Cst may be connected to the second node N2 (or the first electrode of the light emitting element LD). The storage capacitor Cst may be charged with a voltage corresponding to the data signal supplied to the first node N1, and may maintain the charged voltage until the data signal of the next frame is supplied.

In addition, FIG. 3 illustrates the structure of the pixel PX. The structure of the pixel circuit included in the pixel PX may be variously changed and implemented. For example, the pixel circuit may further include various transistors such as a compensation transistor for compensating for a threshold voltage of the first transistor T1, an initialization transistor for initializing the first node N1, and/or an emission control transistor for controlling the emission time of the light emitting element LD, or other circuit elements such as a boosting capacitor for boosting a voltage of the first node N1.

In addition, FIG. 3 shows an embodiment of the present invention in which all transistors (for example, the first to third transistors T1 to T3) included in the pixel circuit are N-type transistors, but the present invention is not limited thereto. For example, at least one of the first to third transistors T1 to T3 may be changed to a P-type transistor.

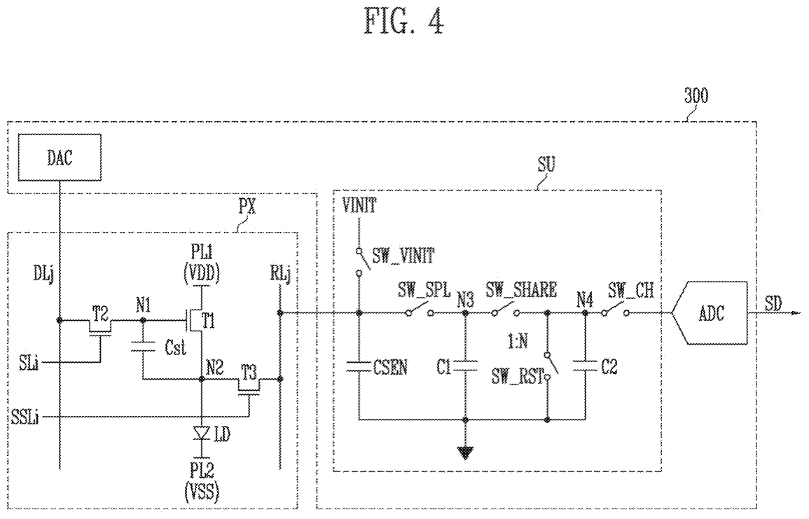

FIG. 4 is a circuit diagram illustrating an example of the data driver included in the display device of FIG. 1 according to an embodiment of the present invention. In addition, in FIG. 4, the data driver 300 is shown as a part of the data driver 300 connected to the pixel PX through the sensing line RLj sensing the characteristics of the pixel PX.

Referring to FIGS. 1, 3, and 4, since the pixel PX may be substantially the same as the pixel PX described with reference to FIG. 3, duplicate descriptions thereof will be omitted.

The data driver 300 may include a digital-to-analog converter DAC. The digital-to-analog converter DAC may generate a voltage (for example, a data voltage) corresponding to a data signal that is corresponding to a data value (or grayscale value) included in frame data (or image data). For example, the digital-to-analog converter DAC may select one of gamma voltages based on the data value, and may output the selected gamma voltage as the data signal (or data voltage).

In addition, the data driver 300 may further include an output buffer, and may provide the data signal to the data line DLj through the output buffer.

The data driver 300 may further include a sensing unit SU that is connected to the sensing line RLj and an analog-to-digital converter ADC.

The sensing unit SU may include a sensing capacitor CSEN, a first capacitor C1, a second capacitor C2, an initialization switch SW_VINIT (or a first switch), a sampling switch SW_SPL (or a second switch), a shared switch SW_SHARE (or a third switch), a reset switch SW_RST (or a fourth switch), and an output switch SW_CH (or a fifth switch).

The initialization switch SW_VINIT may be connected between a power source line to which an initialization voltage VINIT is applied and the sensing line RLj. Here, the initialization voltage VINIT may be provided from a separate power supply (for example, the power supply 400 of FIG. 1), and may have a voltage level lower than the operating point of the light emitting element LD. When the initialization switch SW_VINIT is turned on, the initialization voltage VINIT may be applied to the sensing line RLj. In addition, when the third transistor T3 of the pixel PX is turned on, the initialization voltage VINIT may be applied to the second node N2 of the pixel PX. Since the initialization voltage VINIT has a voltage level lower than the operating point of the light emitting element LD, the light emitting element LD might not emit light when the first transistor T1 is turned on.

The sensing capacitor CSEN may be connected between the sensing line RLj and a reference power source. Here, the reference power source may have a ground voltage, but the present invention is not limited thereto. When the initialization switch SW_VINIT is turned off and the third transistor T3 of the pixel PX is turned on, the sensing capacitor CSEN may be charged by the current provided through the second node N2. That is, characteristic information of the pixel PX provided through the second node N2 may be stored in the sensing capacitor CSEN.

The sampling switch SW_SPL may be connected between the sensing line RLj and a third node N3. The first capacitor C1 may be connected between the third node N3 and the reference power source. While the sampling switch SW_SPL is turned on, the first capacitor C1 may sample the characteristic information of the pixel PX (or the first transistor T1) that is stored in the sensing capacitor CSEN. That is, the data driver 300 may sample the sensing value through the sampling switch SW_SPL and the first capacitor C1.

The shared switch SW_SHARE may be connected between the third node N3 and a fourth node N4. The reset switch SW_RST may be connected between the fourth node N4 and the reference power source. The second capacitor C2 may be connected between the fourth node N4 and the reference power source. When the shared switch SW_SHARE is turned on and the first capacitor C1 and the second capacitor C2 share charge, a node voltage of the fourth node N4 (and a node voltage of the third node N3) may be changed. According to the operation of the shared switch SW_SHARE and the reset switch SW_RST, the shared switch SW_SHARE, the reset switch SW_RST, and the second capacitor C2 may function as a buffer. Here, depending on a ratio of the capacitance of the first capacitor C1 to the second capacitor C2, a gain of the buffer may be N, where N may be an integer greater than 1. For example, the shared switch SW_SHARE, the reset switch SW_RST, and the second capacitor C2 may amplify the node voltage of the third node N3.

The output switch SW_CH may be connected between the fourth node N4 and the analog-to-digital converter ADC, and may connect the fourth node N4 to an input terminal of the analog-to-digital converter ADC. In this case, the node voltage of the fourth node N4 may be applied to the analog-to-digital converter ADC.

In addition, the data driver 300 may further include a capacitor connected between the input terminal of the analog-to-digital converter ADC and the reference power source to maintain the node voltage of the fourth node N4 that is provided to the analog-to-digital converter ADC, and an initialization circuit for initializing the input terminal of the analog-to-digital converter ADC (or, e.g., the capacitor) (for example, a capacitor initialization power source and a switch connecting the capacitor initialization power source to the input terminal of the analog-to-digital converter ADC).

The analog-to-digital converter ADC may convert a voltage provided to the input terminal into a data value (for example, a digital code). For example, the data driver 300 may convert the sensing value sampled through the analog-to-digital converter ADC from an analog form to a digital form. The sensing value (for example, the sensing data SD) in digital form may be provided to the timing controller 500.

In addition, FIG. 4 shows the sensing unit SU configured to include the capacitors CSEN, C1, and C2 and the switches SW_VINIT, SW_SPL, SW_SHARE, SW_RST, and SW_CH as an example, but the configuration of the sensing unit SU is not limited thereto. For example, the sensing unit SU may include various circuits for detecting the node voltage (or current corresponding thereto) of the second node of the pixel PX (for example, a sensing circuit for converting a sensing current into a sensing voltage by using an amplifier, and sampling and holding the converted sensing voltage).

FIG. 5 is a diagram schematically illustrating an example of a method of driving the display device of FIG. 1 according to an embodiment of the present invention. FIG. 5 shows signals provided to the scan lines SL1 to SLn according to time.

Referring to FIGS. 1, 3, and 5, each of frame periods FRAME1 and FRAME2 for one pixel PX or pixel row may include the first scan period P1 and the second scan period P2. The first scan period P1 may be a period in which the pixel PX emits light with a luminance corresponding to the second data DATA2 (for example, image data included in the second data DATA2). The second scan period P2 may be a period in which the pixel PX emits light with a black color and low luminance in response to the black data signal, or the pixel PX does not emit light. Here, the first scan period P1 and the second scan period P2 may be different for each pixel PX. In FIG. 5, for the purpose of clarity, the first scan period P1 and the second scan period P2 corresponding to pixels PX disposed in a first pixel row (for example, pixels PX connected to a first scan line SL1) are shown as an example.

In an embodiment of the present invention, at a start time point of the first scan period P1, a scan signal (or a first scan pulse) of a turn-on voltage level, which is provided to the first scan line SL1, may be supplied to the pixels PX connected to the first scan line SL1. Here, the turn-on voltage level may be a voltage level at which the transistors (for example, the second transistor T2) included in the pixel PX and connected to the scan line (for example, the first scan line SL1) can be turned on. In this case, the pixels PX connected to the first scan line SL1 may emit light with a luminance during the first scan period P1.

As shown in FIG. 5, the scan signal (or the first scan pulse) of the turn-on voltage level may be sequentially provided to the scan lines SL1 to SLn, and the pixels PX corresponding to each of the scan lines SL1 to SLn may sequentially emit light.

In an embodiment of the present invention, at a start time point of the second scan period P2, a scan signal (or a second scan pulse) of a turn-on voltage level provided to the first scan line SL1 may be supplied to the pixels PX connected to the first scan line SL1. In this case, the pixels PX connected to the first scan line SL1 may store a voltage corresponding to the black data signal, and may emit light with the black color and low luminance in response to the black data signal during the second scan period P2.

As shown in FIG. 5, in the second scan period P2, the scan signal (or the second scan pulse) of the turn-on voltage level may be commonly provided to k scan lines among the scan lines SL1 to SLn, and may be provided to the scan lines SL1 to SLn in a step shape as a whole, where k may be a positive integer greater than or equal to 2 and less than n. In this case, a scan time for providing the same black data signal to the pixels PX can be reduced.

As described with reference to FIGS. 1, 3, and 5, the display device 1000 may cause the pixels PX to emit light in the first scan period P1 within one frame period, and in the second scan period P2, may cause the pixels PX to emit light in response to the black image or not to emit light. For example, the display device 1000 may be driven using a black image insertion technology.

FIGS. 6A and 6B are waveform diagrams for explaining an example of an operation of the pixel of FIG. 3 according to an embodiment of the present invention.

First, referring to FIGS. 1, 3, 5, and 6A, during a first sub period PS1 of the first scan period P1, a scan signal (or a first scan pulse) of a turn-on voltage level (for example, a high voltage level) may be applied to the scan line SL1, and a sensing scan signal (or a first sensing scan pulse) of a turn-on voltage level (for example, a high voltage level) may be applied to the sensing scan line SSLi. In addition, a data signal (for example, a data voltage) corresponding to a specific grayscale value may be applied to the data line DLj. For example, a data voltage V_D1 may be applied to the data line DLj.

In this case, the second transistor T2 may be turned on in response to the scan signal of the turn-on voltage level, and a voltage corresponding to the data signal may be provided to one electrode of the storage capacitor Cst. In addition, the third transistor T3 may be turned on in response to the sensing scan signal of the turn-on voltage level, and a voltage applied through the sensing line RLj (for example, the initialization voltage VINIT of FIG. 4) may be provided to the other electrode of the storage capacitor Cst when the third transistor T3 is turned on. Accordingly, a voltage corresponding to the data signal (for example, a voltage corresponding to a difference between the data voltage V_D1 and the initialization voltage) may be stored in the storage capacitor Cst. Thereafter, when the second transistor T2 and the third transistor T3 are turned off, the amount of driving current flowing through the first transistor T1 may be determined in response to the voltage stored in the storage capacitor Cst, and the light emitting element LD may emit light with a luminance corresponding to the amount of driving current during the first scan period P1. Accordingly, in the first scan period P1, an image may be effectively displayed.

Similarly, during a second sub period PS2 of the second scan period P2, a scan signal (or a second scan pulse) of a turn-on voltage level (for example, a high voltage level) may be applied to the scan line SL1, and a sensing scan signal (or a second sensing scan pulse) of a turn-on voltage level (for example, a high voltage level) may be applied to the sensing scan line SSLi. In addition, the data signal applied to the data line DLj may have a black data voltage BLACK corresponding to the black color. Accordingly, during the second scan period P2, the light emitting element LD may display the black color or might not emit light. When the pixel PX displays a moving image, a response time of the pixel PX may be increased due to a sudden change in the data signal (for example, the data voltage). Motion blur may be visually recognized by a user by such an increase in response time. According to an embodiment of the present invention, by inserting the black image in a short black insertion period (for example, the second scan period P2) between display images between frame periods, motion blur of the moving image can be reduced.

The length of the first scan period P1 and the length of the second scan period P2 within one frame period may be determined as values depending on factors such as an image change rate, frequency, and the like.

In addition, in FIG. 6A, the sensing scan signal has the turn-on voltage level (for example, the high voltage level) in the second sub period PS2 of the second scan period P2, but the present invention is not limited thereto.

For example, as shown in FIG. 6B, in the second sub period PS2, the sensing scan signal may have a turn-off voltage level (for example, a low voltage level). In this case, a voltage corresponding to the data signal (for example, the black data voltage BLACK) may be provided to one electrode of the storage capacitor Cst in response to the scan signal, and the first transistor T1 may be turned off. As the storage capacitor Cst maintains the black data voltage BLACK during the second scan period P2, the turned-off state of the first transistor T1 may be maintained.

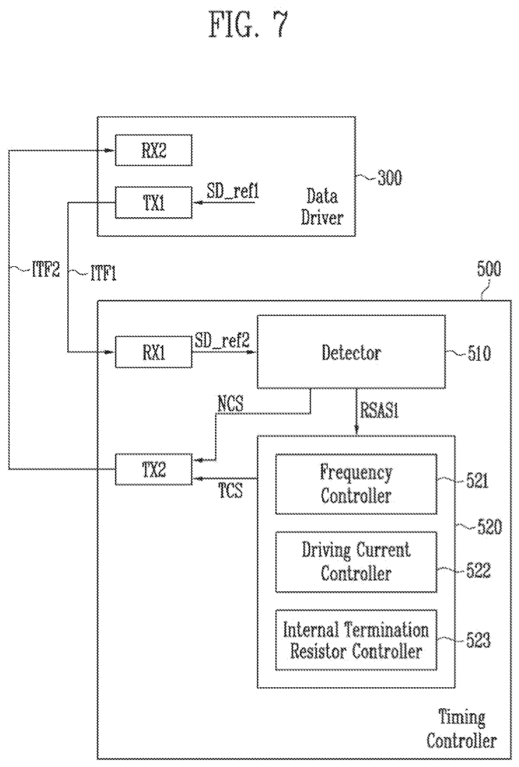

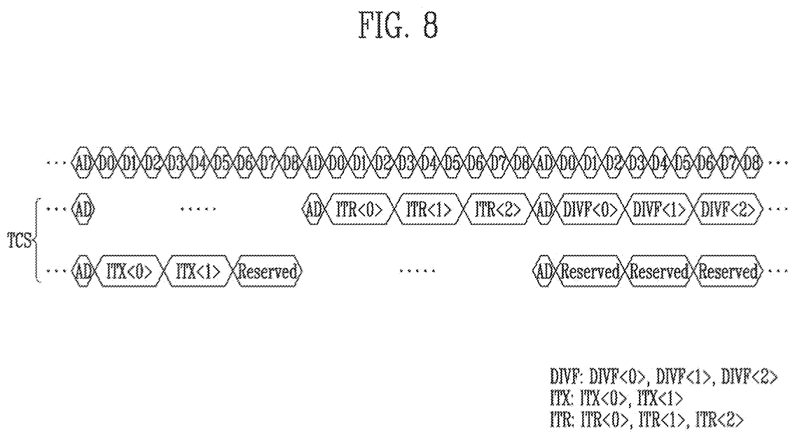

FIG. 7 is a block diagram illustrating an example of the timing controller and the data driver included in the display device of FIG. 1 according to an embodiment of the present invention. FIG. 8 is a diagram for explaining an example of a signal supplied from the timing controller of FIG. 7 to the data driver according to an embodiment of the present invention.

Referring to FIGS. 1 and 7, the display device 1000 according to an embodiment of the present invention may inspect the signal transmission quality of the first interface ITF1 for transmitting the sensing data SD, and change the transmission state of the first interface ITF1 when an error is detected in the sensing data SD that is transmitted through the first interface ITF1.

In an embodiment of the present invention, the display device 1000 may inspect the signal transmission quality of the first interface ITF1 at least once when the display device 1000 is powered on. For example, the display device 1000 may transmit predetermined first reference data SD_ref1, which is a data value (for example, a digital code) at the time of being powered on, from the first transmitter TX1 of the first interface ITF1 to the first receiver RX1, and the display device 100 may inspect the signal transmission quality of the first interface ITF1 by comparing second reference data SD_ref2 received through the first receiver RX1 with the predetermined first reference data SD_ref1. For example, the display device 1000 may inspect the signal transmission quality of the first interface ITF1 by comparing data values of the first reference data SD_ref1 and the second reference data SD_ref2 with each other. However, the present invention is not limited thereto. The display device 1000 may inspect the signal transmission quality of the first interface ITF1 at least once during normal driving after the display device 1000 is powered on.

In addition, when it is determined that an error has occurred in the signal transmission quality of the first interface ITF1 (for example, when an error occurs in the sensing data transmitted through the first interface ITF1) according to the comparison result, the display device 1000 may change the transmission state of the first interface ITF1. For example, the display device 1000 may change the transmission state of the first interface ITF1 by changing at least one of a transmission frequency, a driving current, and a termination resistance of the first interface ITF1.

In addition, the display device 1000 may determine whether an error in the signal transmission quality of the first interface ITF1 is increased (for example, removed) by re-inspecting the signal transmission quality of the first interface ITF1 whose transmission state has been changed. When it is determined that the error has not been fixed (for example, removed), the display device 1000 may further change the transmission state of the first interface ITF1 again.

Hereinafter, focusing on the configuration and operation of the data driver 300 and the timing controller 500, a configuration, in which the display device 1000 according to according to an embodiment of the present invention inspects the signal transmission quality of the first interface ITF1, and a configuration, in which the display device 1000 according to according to an embodiment of the present invention changes the transmission state of the first interface ITF1, will be described in more detail.

The data driver 300 may include the first transmitter TX1 of the first interface ITF1 and the second receiver RX2 of the second interface ITF2. In addition, for clarity, all of the detailed configurations of the data driver 300 described with reference to FIG. 4 are not shown in FIG. 7, but as described with reference to FIG. 4, the data driver 300 may further include the digital-to-analog converter DAC, the sensing unit SU, and the analog-to-digital converter ADC.

In an embodiment of the present invention, the data driver 300 may provide the stored first reference data SD_ref1 to the first transmitter TX1 of the first interface ITF1. The first reference data SD_ref1 may be transmitted to the first receiver RX1 through the signal transmission line of the first interface ITF1 via the first transmitter TX1.

Here, the first reference data SD_ref1 may include a data value (for example, a digital code) corresponding to the sensing data SD (or the sensing value) described with reference to FIGS. 1 and 4. For example, the first reference data SD_ref1 may be digital data having the same number of bits as the sensing data SD.

In addition, the first reference data SD_ref1 may include a predetermined data value (for example, a digital code) having a specific pattern to inspect the signal transmission quality of the first interface ITF1.

The timing controller 500 may include a detector (e.g., a detecting circuit) 510 and a transmission state controller 520. In addition, the timing controller 500 may further include the first receiver RX1 of the first interface ITF1 and the second transmitter TX2 of the second interface ITF2.

The detector 510 may receive the second reference data SD_ref2 from the first receiver RX1. Here, the second reference data SD_ref2 may correspond to the first reference data SD_ref1 that is transmitted to the first receiver RX1 through the signal transmission line of the first interface ITF1 via the first transmitter TX1.

In addition, when there is no error in the signal transmission quality of the first interface ITF1, the first reference data SD_ref1 transmitted through the first interface ITF1 may be transmitted through the first interface ITF1 without a data error. That is, the first reference data SD_ref1 and the second reference data SD_ref2 provided to the first transmitter TX1 may be substantially the same as each other. For example, for each bit, the data value (for example, the digital code) included in the first reference data SD_ref1 and the data value (for example, the digital code) included in the second reference data SD_ref2 may be the same as one another.

In addition, when there is an error in the signal transmission quality of the first interface ITF1, a data error may occur in the first reference data SD_ref1 that is transmitted through the first interface ITF1. For example, when the first transmitter TX1 and/or the first receiver RX1 of the first interface ITF1 are damaged or a short circuit occurs in the signal transmission line of the first interface ITF1, an error may occur in the first reference data SD_ref1. For example, when there is an error in the signal transmission quality of the first interface ITF1, since the transmission frequency and/or driving current of the first interface ITF1 changes or the termination resistance of the first transmitter TX1 and/or first receiver RX1 of the first interface ITF1 changes, an error may occur in data (e.g., the first reference data SD_ref1) transmitted through the first interface ITF1. In this case, the first reference data SD_ref1 and the second reference data SD_ref2 may have different data values (for example, digital codes) from each other. For example, in at least one bit, the first reference data SD_ref1 and the second reference data SD_ref2 may have different data values from each other.

In an embodiment of the present invention, the detector 510 may inspect the signal transmission quality of the first interface ITF1 by comparing the first reference data SD_ref1 with the second reference data SD_ref2. For example, the detector 510 may inspect the signal transmission quality of the first interface ITF1 by comparing the data value of the first reference data SD_ref1 with the data value of the second reference data SD_ref2 for each bit. As described above, since the first reference data SD_ref1 includes the predetermined data value (for example, the digital code) having a specific pattern, the detector 510 may inspect the signal transmission quality of the first interface ITF1 by comparing the data value of the first reference data SD_ref1 with the data value of the second reference data SD_ref2.

For example, when the data values of the first reference data SD_ref1 and the second reference data SD_ref2 are the same for each bit, the detector 510 may determine that there is no error in the signal transmission quality of the first interface ITF1. However, the present invention is not limited thereto. For example, the detector 510 may compare the data value of the first reference data SD_ref1 with the data value of the second reference data SD_ref2 in correspondence to a predetermined bit among bits included in the sensing data SD (or the first reference data SD_ref1), and the detector 510 may determine that there is no error in the signal transmission quality of the first interface ITF1 when the data values of the corresponding bits are the same as one another.

In addition, when the first reference data SD_ref1 and the second reference data SD_ref2 have different data values in at least one bit, the detector 510 may determine that there is an error in the signal transmission quality of the first interface ITF1. However, present invention is not limited thereto. For example, the detector 510 may compare the data value of the first reference data SD_ref1 with the data value of the second reference data SD_ref2 in correspondence to a predetermined bit among bits included in the sensing data SD (or the first reference data SD_ref1), and the detector 510 may determine that there is an error in the signal transmission quality of the first interface ITF1 when the data values of the corresponding bits are different from each other.

In an embodiment of the present invention, the detector 510 may generate a signal for ending the inspection of the signal transmission quality of the first interface ITF1 or a signal for changing the signal transmission state of the first interface ITF1 according to the comparison result.

For example, when there is no error in the signal transmission quality of the first interface ITF1, the detector 510 may generate an inspection end signal NCS and may provide the inspection end signal NCS to the second transmitter TX2 of the second interface ITF2. In this case, the timing controller 500 may provide the inspection end signal NCS to the data driver 300 through the second interface ITF2. The data driver 300 may determine that there is no error in the signal transmission quality of the first interface ITF1 based on the inspection end signal NCS. Accordingly, the inspection of the signal transmission quality of the first interface ITF1 can be finished.

In addition, when there is an error in the signal transmission quality of the first interface ITF1, the detector 510 may generate a first reception state abnormal signal RSAS1.

The transmission state controller 520 may receive the first reception state abnormal signal RSAS1 from the detector 510.

In an embodiment of the present invention, the transmission state controller 520 may generate a transmission state control signal TCS for changing the transmission state of the first interface ITF1 based on the first reception state abnormal signal RSAS1. For example, the transmission state controller 520 may generate the transmission state control signal TCS for changing the transmission state of the first interface ITF1 by changing at least one of the transmission frequency, the driving current, and/or the termination resistance of the first interface ITF1.

To this end, the transmission state controller 520 may include a frequency controller 521, a driving current controller 522, and a termination resistor controller 523.

The frequency controller 521 may change the transmission frequency of the first interface ITF1. For example, the data driver 300 may generate (or, e.g., restore) a clock signal from packet data (for example, the second data DATA2 described with reference to FIG. 1) transmitted from the timing controller 500 through the second interface ITF2, generate a data transmission clock signal (or, e.g., a low-frequency clock signal) having a frequency lower than the restored clock signal by dividing the restored clock signal, and transmit the sensing data SD (or the first reference data SD_ref1) to the timing controller 500 through the first interface ITF1 using the data transmission clock signal. In this case, the data driver 300 may divide the restored clock signal corresponding to a data value of a frequency divider code included in the packet data transmitted through the second interface ITF2. That is, the frequency of the data transmission clock signal may be determined according to a value of the frequency divider code included in the packet data. The frequency controller 521 may change the data transmission frequency of the first interface ITF1 by changing the value of the frequency divider code. For example, the frequency controller 521 may decrease or increase the data transmission frequency of the first interface ITF1.

Here, when the data transmission frequency of the first interface ITF1 is changed (for example, decreased or increased), the reception timing of the sensing data SD (or the first reference data SD_ref1) transmitted through the first interface ITF1 may be changed (for example, the timing at which the timing controller 500 receives the sensing data SD (or the first reference data SD_ref1) through the first receiver RX1 of the first interface ITF1 may be changed). Accordingly, the signal transmission quality of the first interface ITF1 can be increased (for example, removed).

The driving current controller 522 may change the driving current of the first interface ITF1. For example, the first interface ITF1 may transmit the sensing data SD (or the first reference data SD_ref1) using a differential signal (for example, two differential voltages). To this end, the first transmitter TX1 of the first interface ITF1 may include a circuit for converting a series of data bits (for example, the data value of the sensing data SD) into two differential signals and a driver for controlling them through the driving current. Here, a value of the differential signal (for example, a differential voltage) transmitted through the first interface ITF1 may vary according to the driving current output from the driver. For example, the driving current controller 522 may control the value of the differential signal (for example, a difference between differential voltages) transmitted through the first interface ITF1 by changing the driving current of the first interface ITF1. Accordingly, the signal transmission quality of the first interface ITF1 can be increased (for example, removed).

The internal termination resistor controller 523 may change the termination resistance of the first interface ITF1 (for example, the termination resistance of the first transmitter TX1 of the first interface ITF1). For example, as described above, the first interface ITF1 may transmit the sensing data SD using the differential signal. To this end, the first transmitter TX1 of the first interface ITF1 may include a termination resistor. The first interface ITF1 may generate the differential signal (e.g., a differential voltage) based on a voltage generated by a driving current flowing through both terminals of the termination resistor of the first transmitter TX1. Here, a value of the differential signal (e.g., a differential voltage) may vary according to a value of the driving current output from the driver and a value of the termination resistor of the first transmitter TX1. For example, the internal termination resistor controller 523 may control the value of the differential signal (for example, a difference between differential voltages) transmitted through the first interface ITF1 by changing the termination resistance of the first interface ITF1 (for example, the termination resistance of the first transmitter TX1). Accordingly, the signal transmission quality of the first interface ITF1 can be increased (for example, removed).

In an embodiment of the present invention, the transmission state controller 520 may provide the transmission state control signal TCS in the form of digital data to the second interface ITF2 (for example, the second transmitter TX2 of the second interface ITF2) to change the transmission state of the first interface ITF1 (for example, at least one of the transmission frequency, the driving current, and/or the termination resistance of the first interface ITF1). For example, the transmission state controller 520 may generate the transmission state control signal TCS including a digital code for changing at least one of the transmission frequency, the driving current, and/or the termination resistance of the first interface ITF1, and the transmission state controller 520 may provide the transmission state control signal TCS to the second transmitter TX2 of the second interface ITF2.

In an embodiment of the present invention, the data driver 300 may receive the transmission state control signal TCS through the second transmitter TX2 and the second receiver RX2 of the second interface ITF2, and change at least one of the transmission frequency, the driving current, and/or the termination resistance of the first interface ITF1 in response to a digital code value included in the transmission state control signal TCS.

For example, referring further to FIG. 8, FIG. 8 shows an example of the transmission state control signal TCS transmitted through the second interface ITF2.

In the transmission state control signal TCS, 10 bits AD, D0, D1, D2, D3, D4, D5, D6, D7, and D8 may form unit data. Each unit data may include a transition bit AD. It may be set differently depending on a product, but the transition bit AD may be set to have a different level from that of the previous bit or set to have a different level from that of the next bit.

In an embodiment of the present invention, the transmission state control signal TCS may include a frequency divider code DIVF. For example, the frequency divider code DIVF may be composed of 3 bits DIVF<0>, DIVF<1>, and DIVF<2>. The data transmission frequency of the first interface ITF1 may be changed according to a data value (for example, a digital code) of the frequency divider code DIVF. For example, the data driver 300 may determine the frequency of the data transmission clock signal in response to the data value of the frequency divider code DIVF. For example, the frequency divider code DIVF may be generated by the frequency controller 521.

In addition, the transmission state control signal TCS may include a driving current code ITX. For example, the driving current code ITX may be composed of 2 bits ITX<0> and ITX<1>. The data driver 300 may determine a value of the driving current for generating the differential signal in the first transmitter TX1 of the first interface ITF1 in response to a data value (for example, a digital code) of the driving current code ITX. For example, the driving current code ITX may be generated by the driving current controller 522.

In addition, the transmission state control signal TCS may include a termination resistance code ITR. For example, the termination resistance code ITR may be composed of 3 bits ITR<0>, ITR<1>, and ITR<2>. The data driver 300 may determine the value of the termination resistance of the first transmitter TX1 of the first interface ITF1 for generating the differential signal in response to a data value (for example, a digital code) of the termination resistance code ITR. For example, the termination resistance code ITR may be generated by the termination resistor controller 523.

In addition, in the above, an embodiment of the present invention, in which the timing controller 500 (for example, the transmission state controller 520) changes the transmission state of the first interface ITF1 when there is an error in the signal transmission quality of the first interface ITF1, has been described as an example. The change of the transmission state of the first interface ITF1 may be achieved by changing at least one of the transmission frequency, the driving current, and/or the termination resistance of the first interface ITF1, as illustrated in the example. However, the present invention is not limited thereto.

For example, the transmission state controller 520 may sequentially change the transmission frequency, the driving current, and the termination resistance of the first interface ITF1 to change the transmission state of the first interface ITF1 based on the first reception state abnormal signal RSAS1.

For example, the transmission state controller 520 (for example, the frequency controller 521) may generate the transmission state control signal TCS (or a first transmission state control signal) for changing the transmission frequency of the first interface ITF1, and provide the transmission state control signal TCS to the data driver 300 through the second interface ITF2. Thereafter, the data driver 300 may transmit the first reference data SD_ref1 to the timing controller 500 through the first transmitter TX1 of the first interface ITF1 whose transmission frequency is changed based on the transmission state control signal TCS. The detector 510 of the timing controller 500 may re-inspect the signal transmission quality of the interface ITF1 by comparing the second reference data SD_ref2 received through the first receiver RX1 of the first interface ITF1 with the predetermined first reference data SD_ref1.

When it is determined that the error in the signal transmission quality of the first interface ITF1 is increased (for example, removed) according to the comparison result, the detector 510 may generate the inspection end signal NCS and provide the inspection end signal NCS to the second transmitter TX2 of the second interface ITF2, so that the inspection of the signal transmission quality of the first interface ITF1 can be finished.

In addition, when it is determined that the error in the signal transmission quality of the first interface ITF1 is not increased (for example, removed) according to the comparison result, the detector 510 may re-generate the first reception state abnormal signal RSAS1.

Thereafter, the transmission state controller 520 (for example, the driving current controller 522) may generate the transmission state control signal TCS (or a second transmission state control signal) for changing the driving current of the first interface ITF1, and the transmission state controller 520 may provide the transmission state control signal TCS to the data driver 300 through the second interface ITF2. Thereafter, the data driver 300 may transmit the first reference data SD_ref1 to the timing controller 500 through the first transmitter TX1 of the first interface ITF1 whose driving current is changed based on the transmission state control signal TCS. The detector 510 of the timing controller 500 may re-inspect the signal transmission quality of the interface ITF1 by comparing the second reference data SD_ref2 received through the first receiver RX1 of the first interface ITF1 with the predetermined first reference data SD_ref1.

When it is determined that the error in the signal transmission quality of the first interface ITF1 is increased (for example, removed) according to the comparison result, the detector 510 may generate the inspection end signal NCS and provide the inspection end signal NCS to the second transmitter TX2 of the second interface ITF2, so that the inspection of the signal transmission quality of the first interface ITF1 can be finished.

In addition, when it is determined that the error in the signal transmission quality of the first interface ITF1 is not increased (for example, removed) according to the comparison result, the detector 510 may re-generate the first reception state abnormal signal RSAS1.

Thereafter, the transmission state controller 520 (for example, the termination resistor controller 523) may generate the transmission state control signal TCS (or a third transmission state control signal) for changing the termination resistance of the first interface ITF1 (for example, the termination resistance of the first transmitter TX1) and may provide the transmission state control signal TCS to the data driver 300 through the second interface ITF2. Thereafter, the data driver 300 may transmit the first reference data SD_ref1 to the timing controller 500 through the first transmitter TX1 of the first interface ITF1 whose termination resistance is changed based on the transmission state control signal TCS. The detector 510 of the timing controller 500 may re-inspect the signal transmission quality of the interface ITF1 by comparing the second reference data SD_ref2 received through the first receiver RX1 of the first interface ITF1 with the predetermined first reference data SD_ref1.

As described above, the timing controller 500 may inspect the signal transmission quality of the first interface ITF1 by sequentially changing the transmission frequency, the driving current, and the termination resistance of the first interface ITF1.

In addition, in the above, an embodiment of the present invention in which the timing controller 500 (for example, the transmission state controller 520) changes the transmission state of the first interface ITF1 by sequentially changing the transmission frequency, the driving current, and the termination resistance of the first interface ITF1 has been described as an example. However, the order in which the timing controller 500 (for example, the transmission state controller 520) changes the transmission state of the first interface ITF1 may be set in various ways.

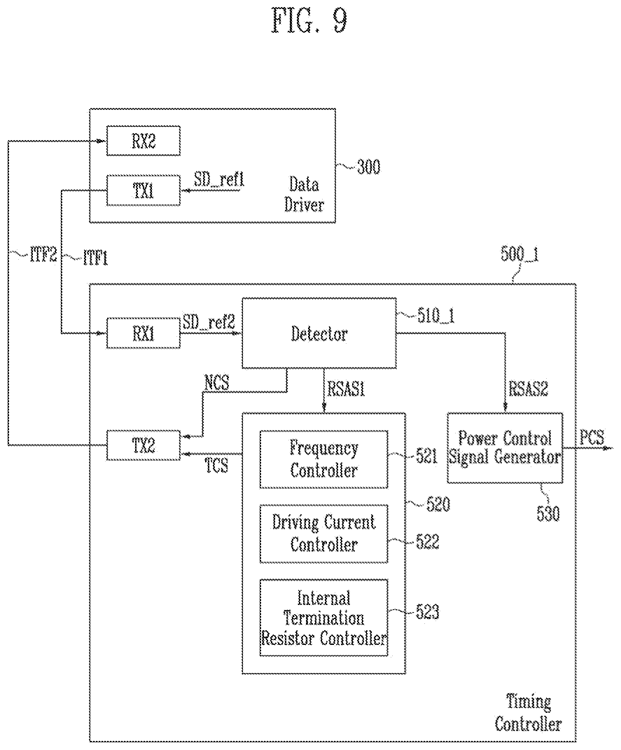

FIG. 9 is a block diagram illustrating an example of the timing controller and the data driver included in the display device of FIG. 1 according to an embodiment of the present invention. In addition, except for a configuration in which a timing controller 500_1 further includes a power control signal generator 530 and a detector 510_1 that additionally generates a second reception state abnormal signal RSAS2 as shown in FIG. 9, the timing controller 500_1 and a data driver 300 of FIG. 9 may be substantially the same as or similar to the timing controller 500 and the data driver 300 described with reference to FIG. 7. Therefore, duplicate descriptions thereof will be omitted.

Referring to FIGS. 1 and 9, the timing controller 500_1 of the display device 1000 according to an embodiment of the present invention may include a detector 510_1, a transmission state controller 520, and a power control signal generator 530.

In an embodiment an embodiment of the present invention, when there is an error in the signal transmission quality of the first interface ITF1, the detector 510_1 may generate the second reception state abnormal signal RSAS2.

For example, when the number of different bits between the data values of the first reference data SD_ref1 and the data values of the second reference data SD_ref2 is relatively large, the signal transmission quality might not be increased (e.g., removed) even when the signal transmission state of the first interface ITF1 is changed. Accordingly, the detector 510_1 may compare the first reference data SD_ref1 with the second reference data SD_ref2 for each bit. As a result, when the number of different bits between the data values of the first reference data SD_ref1 and the data values of the second reference data SD_ref2 is greater than or equal to a predetermined value (for example, the predetermined number of bits), the detector 510_1 might not change the transmission state of the first interface ITF1, and may generate the second reception state abnormal signal RSAS2 for cutting off the supply of the power source (for example, the first power source VDD and/or the second power source VSS) for operating the pixel unit 100.

The power control signal generator 530 may generate a power control signal PCS for cutting off the power supply from the first power source VDD and/or the second power source VSS based on the second reception state abnormal signal RSAS2. The power supply 400 may cut off the power supply from the first power source VDD and/or the second power source VSS supplied to the pixel unit 100 based on the power control signal PCS.

As another example, when the signal transmission quality of the first interface ITF1 is not increased (for example, removed) even when the transmission state of the first interface ITF1 is changed, the detector 510_1 may generate the second reception state abnormal signal RSAS2 for cutting off the supply of the power source (for example, the first power source VDD and/or the second power source VSS) for operating the pixel unit 100. As an example, as described with reference to FIG. 7, when the error in the signal transmission quality of the first interface ITF1 is not increased (for example, removed) even when the timing controller 500 (for example, the transmission state controller 520) sequentially changes the transmission frequency, the driving current, and the termination resistance of the first interface ITF1 and inspects the data (for example, the first reference data SD_ref1 and the second reference data SD_ref2) transmitted through the first interface ITF1 in the changed transmission state, the detector 510_1 may generate the second reception state abnormal signal RSAS2.

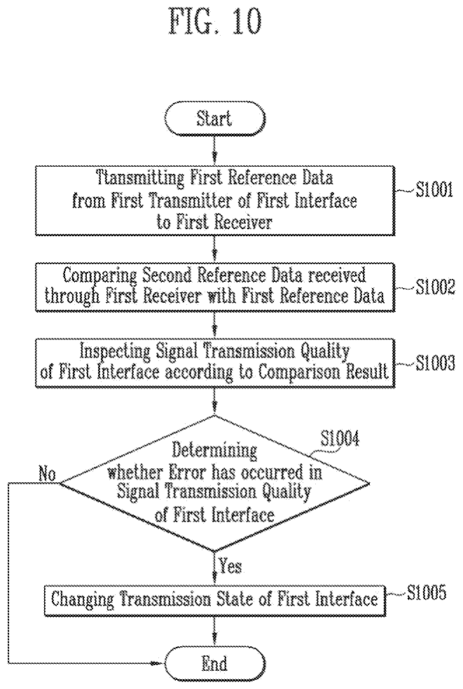

FIG. 10 is a flowchart illustrating a method of driving a display device according to an embodiment of the present invention. In addition, a method of driving a display device according to an embodiment of the present invention shown in FIG. 10 may be performed using the display device 1000 of FIG. 1. Therefore, hereinafter, descriptions overlapping with those described with reference to FIGS. 1 and 7 to 9 will be omitted.

Referring to FIG. 10, the method of driving the display device of FIG. 10 may include transmitting first reference data from a first transmitter of a first interface to a first receiver (S1001), comparing second reference data received through the first receiver with the first reference data (S1002), inspecting signal transmission quality of the first interface according to the comparison result (S1003), and determining whether an error has occurred in the signal transmission quality of the first interface (S1004).

In the transmitting the first reference data from the first transmitter of the first interface to the first receiver (S1001), the data driver 300 described with reference to FIGS. 1 and 7 may transmit the first reference data SD_ref1 from the first transmitter TX1 of the first interface ITF1 to the first receiver RX1. For example, the first reference data SD_ref1 may be transmitted from the first transmitter TX1 of the first interface ITF1 to the first receiver RX1 of the timing controller 500.

In the comparing the second reference data received through the first receiver with the first reference data (S1002), the detector 510 of the timing controller 500 described with reference to FIGS. 1 and 7 may compare the second reference data SD_ref2 received through the first receiver RX1 with the predetermined first reference data SD_ref1.

In the inspecting the signal transmission quality of the first interface according to the comparison result (S1003) and in the determining whether an error has occurred in the signal transmission quality of the first interface (S1004), the detector 510 of the timing controller 500 described with reference to FIGS. 1 and 7 may determine whether an error has occurred in the signal transmission quality of the first interface ITF1 according to the comparison result.

In addition, when no error occurs in the signal transmission quality of the first interface (No), the driving of the display device for inspecting the signal transmission quality of the first interface can be finished. For example, as described with reference to FIGS. 1 and 7, in the method of driving the display device of FIG. 10, the inspection end signal (for example, the inspection end signal NCS described with reference to FIG. 7) may be generated and provided to the data driver (for example, the data driver 300 of FIG. 7) through a second interface (for example, the second interface ITF2 of FIG. 7).

In addition, when an error occurs in the signal transmission quality of the first interface (Yes), the method of driving the display device of FIG. 10 may further include changing the transmission state of the first interface (S1005). In the changing the transmission state of the first interface (S1005), the detector 510 described with reference to FIGS. 1 and 7 may generate the first reception state abnormal signal RSAS1, and the transmission state controller 520 may generate the transmission state control signal TCS for changing the transmission state of the first interface ITF1 based on the first reception state abnormal signal RSAS1. As described with reference to FIGS. 1 and 7, in an embodiment of the present invention, the transmission state of the first interface (for example, the first interface ITF1 of FIG. 7) may include at least one of a transmission frequency, a driving current, and/or a termination resistance of the first interface (for example, the first interface ITF1 of FIG. 7).

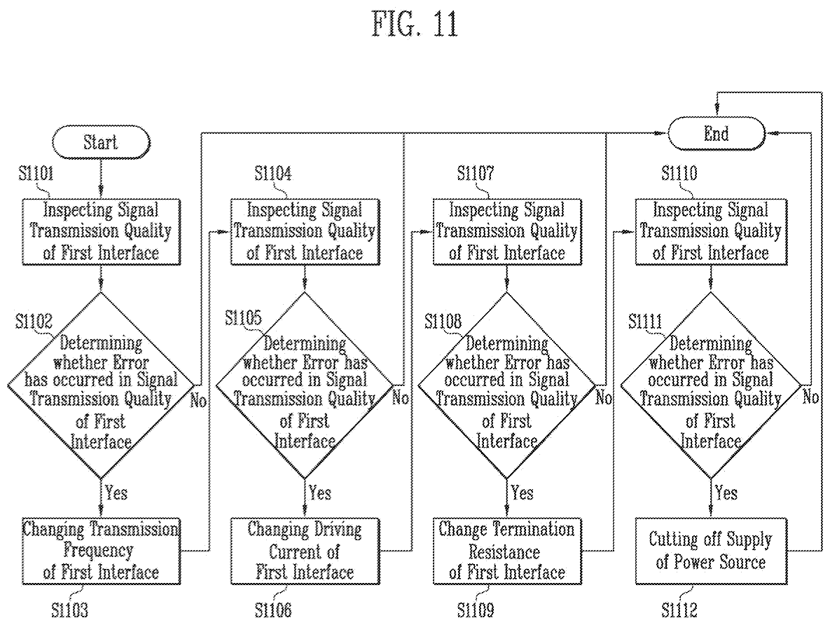

FIG. 11 is a flowchart illustrating a method of driving a display device according to an embodiment of the present invention. In addition, a method of driving a display device according to an embodiment of the present invention shown in FIG. 11 may be performed using the display device 1000 of FIG. 1. Therefore, hereinafter, descriptions overlapping with those described with reference to FIGS. 1 and 7 to 9 will be omitted.

In addition, as described with reference to FIG. 9, the display device 1000 according to an embodiment of the present invention may inspect the signal transmission quality of the first interface ITF1 and change the transmission state of the first interface ITF1 when it is determined that there is an error in the signal transmission quality of the first interface ITF1. In addition, the display device 1000 may cut off the supply of the power source for operating the pixel unit 100 when the signal transmission quality of the first interface ITF1 is not increased (for example, removed) even when the transmission state of the first interface ITF1 is changed.

Referring to FIG. 11, the method of driving the display device according to an embodiment of the present invention may inspect the signal transmission quality of the first interface, and sequentially change the transmission frequency, the driving current, and the termination resistance of the first interface to change the transmission state of the first interface when there is an error in the signal transmission quality of the first interface. In addition, the method of driving the display device may cut off the supply of the power source when the signal transmission quality of the first interface is not increased (for example, removed) even when the transmission state of the first interface is changed.

Hereinafter, embodiments will be described with reference to FIGS. 1 and 9 together with FIG. 11, and the reference numerals referred to in FIGS. 1 and 9 will be added.

The method of driving the display device of FIG. 11 may include inspecting the signal transmission quality of the first interface ITF1 (S1101) and determining whether an error has occurred in the signal transmission quality of the first interface ITF1 (S1102). When an error does not occur in the signal transmission quality of the first interface ITF1 (No), the driving of the display device 1000 for inspecting the signal transmission quality of the first interface ITF1 can be finished.

In addition, when an error occurs in the signal transmission quality of the first interface ITF1 (Yes), the method of driving the display device of FIG. 11 may change the transmission frequency of the first interface ITF1 (S1103).

Thereafter, the method of driving the display device of FIG. 11 may include inspecting the signal transmission quality of the first interface ITF1 (S1104) and determining whether an error has occurred in the signal transmission quality of the first interface ITF1 (S1105). When an error does not occur in the signal transmission quality of the first interface ITF1 (No), the driving of the display device 1000 for inspecting the signal transmission quality of the first interface ITF1 can be finished.

In addition, when an error occurs in the signal transmission quality of the first interface ITF1 (Yes), the method of driving the display device of FIG. 11 may change the driving current of the first interface ITF1 (S1106).

Thereafter, the method of driving the display device of FIG. 11 includes inspecting the signal transmission quality of the first interface ITF1 (S1107) and determining whether an error has occurred in the signal transmission quality of the first interface ITF1 (S1108). When an error does not occur in the signal transmission quality of the first interface ITF1 (No), the driving of the display device 1000 for inspecting the signal transmission quality of the first interface ITF1 can be finished.

In addition, when an error occurs in the signal transmission quality of the first interface ITF1 (Yes), the method of driving the display device of FIG. 11 may change the termination resistance of the first interface ITF1 (S1109).

Thereafter, the method of driving the display device of FIG. 11 may include inspecting the signal transmission quality of the first interface ITF1 (S1110) and determining whether an error has occurred in the signal transmission quality of the first interface ITF1 (S1111). When an error does not occur in the signal transmission quality of the first interface ITF1 (No), the driving of the display device 1000 for inspecting the signal transmission quality of the first interface ITF1 can be finished.

In addition, when an error occurs in the signal transmission quality of the first interface ITF1 (Yes), the method of driving the display device of FIG. 11 may cut off the supply of the power source (S1112). In the cutting off the supply of the power source (S1112), the detector 510_1 described with reference to FIGS. 1 and 9 may generate the second reception state abnormal signal RSAS2 for cutting off the supply of the power source (for example, the first power source VDD and/or the second power VSS) for operating the pixel unit 100. In addition, the power control signal generator 530 may generate the power control signal PCS based on the second reception state abnormal signal RSAS2, and the pixel unit 100 may be cut off from the power supply 400 that provides the first power source VDD and/or the second power source VSS.

The display device and the method of driving the same according to an embodiment of the present invention may inspect the signal transmission quality of the first interface and change the transmission state of the first interface when an error is detected in data (e.g., sensing data) transmitted through the first interface. Accordingly, the signal transmission quality of the first interface can be increased.

In addition, the display device and the method of driving the same according to an embodiment of the present invention may block generation of the driving power source (for example, the first power source and/or second power source) required to operate the pixel unit when an error is detected in the data (e.g., sensing data) transmitted through the first interface. Accordingly, displaying the image according to the miscorrected image data can be prevented.

However, effects of the present invention are not limited to the above-described effects, and may be variously extended without departing from the spirit and scope of the present invention.

While the present invention has been particularly shown and described with reference to embodiments thereof, it will be apparent those of ordinary skill in the art that various changes in form and detail may be made thereto without departing from spirit and scope of the present invention.

What is claimed is:

1. A display device comprising:
a first interface;
a data driver providing first reference data to a first transmitter of the first interface; and
a timing controller receiving second reference data through a first receiver of the first interface and comparing the first reference data with the second reference data to inspect signal transmission quality of the first interface for an error, wherein the first reference data is transmitted from the first transmitter to the first receiver via the first interface,
wherein the timing controller changes a transmission state of the first interface when an error is detected in the signal transmission quality of the first interface, and
wherein the transmission state of the first interface includes at least one of a transmission frequency, a driving current, or a termination resistance of the first interface.

2. The display device of claim 1, wherein the timing controller includes:
a detector comparing the first reference data with the second reference data to inspect the signal transmission quality of the first interface; and
a transmission state controller changing the transmission state of the first interface.

3. The display device of claim 2, wherein the detector compares a data value of the first reference data with a data value of the second reference data for each bit to inspect the signal transmission quality of the first interface, and
wherein the detector determines that there is an error in the signal transmission quality of the first interface when the first reference data and the second reference data have different data values from each other in at least one bit.

4. The display device of claim 2, wherein the detector generates a first reception state abnormal signal when there is an error in the signal transmission quality of the first interface, and
wherein the transmission state controller generates a transmission state control signal for changing the transmission state of the first interface based on the first reception state abnormal signal.

5. The display device of claim 4, further comprising:
a second interface,
wherein the timing controller provides the transmission state control signal to a second transmitter of the second interface, and
wherein the data driver changes at least one of the transmission frequency, the driving current, or the termination resistance of the first interface based on the transmission state control signal.

6. The display device of claim 2, wherein the transmission state controller includes:
a frequency controller generating a frequency divider code for controlling a frequency of a data transmission clock signal of the first interface;
a driving current controller generating a driving current code for controlling a driving current of the first transmitter of the first interface; and
a termination resistor controller generating a termination resistance code for controlling a termination resistance of the first transmitter of the first interface.

7. The display device of claim 2, wherein the detector generates an inspection end signal and provides the inspection end signal to the data driver when there is no error in the signal transmission quality of the first interface.

8. The display device of claim 3, wherein the first reference data includes a predetermined data value having a specific pattern.

9. The display device of claim 1, wherein the timing controller sequentially changes the transmission frequency, the driving current, and the termination resistance of the first interface when an error is detected in the signal transmission quality of the first interface.

10. The display device of claim 2, further comprising:
a power supply generating a driving power source,
wherein the timing controller blocks generation of the driving power source of the power supply when an error is detected in the signal transmission quality of the first interface.

11. A display device comprising:
a first interface;
a power supply generating a driving power source;
a data driver providing first reference data to a first transmitter of the first interface, and
a timing controller receiving second reference data through a first receiver of the first interface and comparing the first reference data with the second reference data to inspect signal transmission quality of the first interface for an error, wherein the first reference data is transmitted from the first transmitter to the first receiver via the first interface,
wherein the timing controller blocks generation of the driving power source of the power supply when an error is detected in the signal transmission quality of the first interface.

12. A method of driving a display device comprising:
transmitting first reference data from a first transmitter of a first interface to a first receiver;
comparing second reference data received through the first receiver with the first reference data;
inspecting signal transmission quality of the first interface for an error according to a comparison result between the first reference data and the second reference data; and
changing transmission state of the first interface when it is determined that an error has occurred in the signal transmission quality of the first interface in the inspecting of the signal transmission quality,
wherein the transmission state of the first interface includes at least one of a transmission frequency, a driving current, or a termination resistance of the first interface.

13. The method of claim 12, wherein in the comparing of the second reference data with the first reference data, a data value of the first reference data and a data value of the second reference data are compared to each other for each bit.

14. The method of claim 13, wherein in the inspecting of the signal transmission quality of the first interface, it is determined that there is an error in the signal transmission quality of the first interface when the first reference data and the second reference data have different data values from each other in at least one bit.

15. The method of claim 13, wherein the first reference data includes a predetermined data value having a specific pattern.

16. The method of claim 12, wherein the changing of the transmission state of the first interface includes:
generating a frequency divider code for controlling a frequency of a data transmission clock signal of the first interface.

17. The method of claim 12, wherein the changing of the transmission state of the first interface includes:
generating a drive current code for controlling a drive current of the first transmitter of the first interface.

18. The method of claim 12, wherein the changing of the transmission state of the first interface includes:
generating a termination resistance code for controlling a termination resistance of the first transmitter of the first interface.

19. The method of claim 12, wherein the changing of the transmission state of the first interface includes sequentially changing the transmission frequency, the driving current, and the termination resistance of the first interface.

20. The method of claim 12, wherein the inspecting of the signal transmission quality of the first interface includes:
blocking generation of a driving power source when it is determined that an error has occurred in the signal transmission quality of the first interface.
